(19) United States
(12) Patent Application Publication
(10) Pub. No.: US 2020/0132462 A1
(43) Pub. Date: Apr. 30, 2020

(54) SENSOR CALIBRATION DEVICE AND SENSOR CALIBRATION PROGRAM PRODUCT

(71) Applicant: DENSO CORPORATION, Kariya-city (JP)

(72) Inventors: Shunsuke SHIBATA, Nisshin-city (JP); Masayuki IMANISHI, Nisshin-city (JP); Norio SAMMA, Nisshin-city (JP); Takeshi HATO, Kariya-city (JP); Takeshi KAWASHIMA, Kariya-city (JP); Daisuke TAKEMORI, Kariya-city (JP); Hiroto BANNO, Kariya-city (JP); Sei IGUCHI, Kariya-city (JP)

(21) Appl. No.: 16/726,419

(22) Filed: Dec. 24, 2019

Related U.S. Application Data
(63) Continuation of application No. PCT/JP2018/025025, filed on Jul. 2, 2018.

(30) Foreign Application Priority Data
Jul. 18, 2017 (JP) 2017-139339
Jun. 19, 2018 (JP) 2018-116304

(51) Int. Cl. G01C 21/16; B60W 30/14

(52) U.S. Cl. CPC G01C 21/16; B60W 30/143

(57) ABSTRACT

A sensor calibration device acquires a measured value of an attitude of a vehicle based on an output of an attitude sensor, acquires vehicle speed information indicating a traveling speed of the vehicle, acquires map information on a road on which the vehicle travels, and sets a calibration value applied to the measured value to cause a calculated position of the vehicle calculated based on the vehicle speed information and the measured value to come close to a reference position indicated in the map information.

### CROSS REFERENCE TO RELATED APPLICATIONS

The present application is a continuation application of International Patent Application No. PCT/JP2018/025025 filed on Jul. 2, 2018, which designated the U.S. and claims the benefit of priority from Japanese Patent Application No. 2017-139339 filed on Jul. 18, 2017 and Japanese Patent Application No. 2018-116304 filed on Jun. 19, 2018. The entire disclosures of all of the above applications are incorporated herein by reference.

### TECHNICAL FIELD

The present disclosure relates to a sensor calibration device and a sensor calibration program product.

### BACKGROUND

As some types of attitude sensors for measuring an attitude of a vehicle, an acceleration sensor, an angular velocity sensor, and the like have been known.

### SUMMARY

According to one aspect of the present disclosure, a measured value of an attitude of a vehicle is acquired based on an output of an attitude sensor, vehicle speed information indicating a traveling speed of the vehicle is acquired, map information on a road on which the vehicle travels is acquired, and a calibration value applied to the measured value is set to cause a calculated position of the vehicle calculated based on the vehicle speed information and the measured value to come close to a reference position indicated in the map information.

According to another aspect of the present disclosure, a measured value of an attitude of a vehicle is acquired based on an output of an attitude sensor, vehicle speed information indicating a traveling speed of the vehicle is acquired, a positioning position of the vehicle is identified based on a positioning signal received from a positioning satellite, and a calibration value applied to the measured value is set to cause a calculated position of the vehicle calculated based on the vehicle speed information and the measured value to come close to the positioning position identified by the position identification section.

According to another aspect of the present disclosure, a measured value of a displacement of a vehicle is acquired based on an output of an attitude sensor, vehicle speed information indicating a traveling speed of the vehicle is acquired, altitude information on a road on which the vehicle travels is acquired, and a calibration value applied to the measured value is set to cause a calculated position of the vehicle calculated based on the vehicle speed information and the measured value to come close to a reference position indicated in the altitude information.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing an overall image of a system mounted on a vehicle including a display control device according to a first embodiment of the present disclosure;

FIG. 2A is a diagram showing a process of matching a calculated traveling locus with a traveling locus based on map data in a visualized manner in order to set a calibration coefficient (prior to calibration);

FIG. 2B is a diagram showing a process of matching the calculated traveling locus with the traveling locus based on the map data in order to set the calibration coefficient (after calibration);

FIG. 3 is a flowchart showing details of an update process of the calibration coefficient;

FIG. 4 is a flowchart showing details of a data selection process;

FIG. 5 is a flowchart showing details of an update process according to a second embodiment;

FIG. 6 is a block diagram showing an overall image of a system mounted on a vehicle including a display control device according to a third embodiment;

FIG. 7 is a diagram showing a process of matching a calculated host vehicle altitude with a host vehicle altitude based on the map data in a visualized manner in order to set the calibration coefficient;

FIG. 8 is a flowchart showing details of an update process according to the third embodiment;

FIG. 9 is a flowchart showing details of a data selection process;

FIG. 10 is a flowchart showing a data selection process according to Modification 1;

FIG. 11 is a flowchart showing a data selection process according to Modification 2; and

FIG. 12 is a flowchart showing a data selection process according to Modification 3.

### DETAILED DESCRIPTION

In attitude sensors, an output may change due to, for example, change in ambient temperature, an individual difference, or the like. Therefore, a correction device may be provided to calibrate the output of the attitude sensor based on a measured ambient temperature of the attitude sensor and a temperature specifying data stored in advance.

In recent years, various types of information for highly assisting driving of a driver can be acquired by a vehicle. The inventors of the present disclosure have repeatedly investigated whether the output of the attitude sensor can be calibrated by using such information that can be obtained by the vehicle.

According to one aspect of the present disclosure, a sensor calibration device includes a control circuit configured to acquire a measured value of an attitude of a vehicle based on an output of an attitude sensor, acquire vehicle speed information indicating a traveling speed of the vehicle, acquire map information on a road on which the vehicle travels, and set a calibration value applied to the measured value to cause a calculated position of the vehicle calculated based on the vehicle speed information and the measured value to come close to a reference position indicated in the map information.

According to one aspect of the present disclosure, a sensor calibration program product is stored in a non-transitory tangible storage medium and causes at least one processor to function as a measured value acquisition section that acquires a measured value of an attitude of a vehicle based on an output of an attitude sensor, a vehicle speed acquisition section that acquires vehicle speed information indicating a traveling speed of the vehicle, a map information acquisition section that acquires map information of a road on which the vehicle travels, and a calibration value setting section that sets a calibration value applied to the measured value to cause a calculated position of the vehicle calculated based on the vehicle speed information and the measured value to come close to a reference position indicated in the map information.

As in those aspects, the measured value of the attitude sensor and the vehicle speed information are combined with each other, thereby being capable of acquiring the calculated position based on the measured value of the attitude sensor. If the calibration value is set so that the calculated position comes close to the reference position indicated in the map information, the attitude sensor can be calibrated by using the map information.

According to one aspect of the present disclosure, a sensor calibration device includes a control circuit configured to acquire a measured value of an attitude of a vehicle based on an output of an attitude sensor, acquire vehicle speed information indicating a traveling speed of the vehicle, identify a positioning position of the vehicle based on a positioning signal received from a positioning satellite, and set a calibration value applied to the measured value to cause a calculated position of the vehicle calculated based on the vehicle speed information and the measured value to come close to the positioning position identified by the position identification section.

According to one aspect of the present disclosure, a sensor calibration program product is stored in a non-transitory tangible storage medium and causes at least one processor to function as a measured value acquisition section that acquires a measured value of an attitude of a vehicle based on an output of an attitude sensor, a vehicle speed acquisition section that acquires vehicle speed information indicating a traveling speed of the vehicle, a position identification section that identifies a positioning position of the vehicle based on a positioning signal received from a satellite, and a calibration value setting section that sets a calibration value applied to the measured value to cause a calculated position of the vehicle calculated based on the vehicle speed information and the measured value to come close to the positioning position identified by the position identification section.

In those aspects, the calibration value of the attitude sensor is set so that the calculated position based on the vehicle speed information and the measured value comes close to the positioning position identified based on the positioning signal. As described above, the attitude sensor can be calibrated by using the positioning signal received from the satellite.

According to one aspect of the present disclosure, a sensor calibration device includes a control circuit configured to acquire a measured value of a displacement of a vehicle based on an output of the attitude sensor, acquire vehicle speed information indicating a traveling speed of the vehicle, acquire altitude information on a road on which the vehicle travels, and set a calibration value applied to the measured value to cause a calculated position of the vehicle calculated based on the vehicle speed information and the measured value to come close to a reference position indicated in the altitude information.

According to one aspect of the present disclosure, a sensor calibration program product is stored in a non-transitory tangible storage medium and causes at least one processor to function as a measured value acquisition section that acquires a measured value of a displacement of a vehicle based on an output of an attitude sensor, a vehicle speed acquisition section that acquires vehicle speed information indicating a traveling speed of the vehicle, an altitude information acquisition section that acquires altitude information of a road on which the vehicle travels, and a calibration value setting section that sets a calibration value applied to the measured value to cause a calculated position of the vehicle calculated based on the vehicle speed information and the measured value to come close to a reference position indicated in the altitude information.

In those aspects, the measured value of the attitude sensor and the vehicle speed information are combined together, thereby being capable of acquiring the calculated position of the altitude based on the measured value of the displacement of the vehicle. If the calibration value is set so that the calculated position comes close to the reference position indicated by the altitude information, the attitude sensor can be calibrated by using the altitude information.

Hereinafter, a plurality of embodiments of the present disclosure will be described with reference to the drawings. Incidentally, the same reference numerals are assigned to the corresponding components in each embodiment, and thus, duplicate descriptions may be omitted. When only a part of the configuration is described in each embodiment, the configuration of the other embodiments described above can be applied to other parts of the configuration. Further, not only the combinations of the configurations explicitly shown in the description of the respective embodiments, but also the configurations of the plurality of embodiments can be partially combined even if the combinations are not explicitly shown if there is no problem in the combination in particular. Unspecified combinations of the configurations described in the plurality of embodiments and the modification examples are also disclosed in the following description.

### First Embodiment

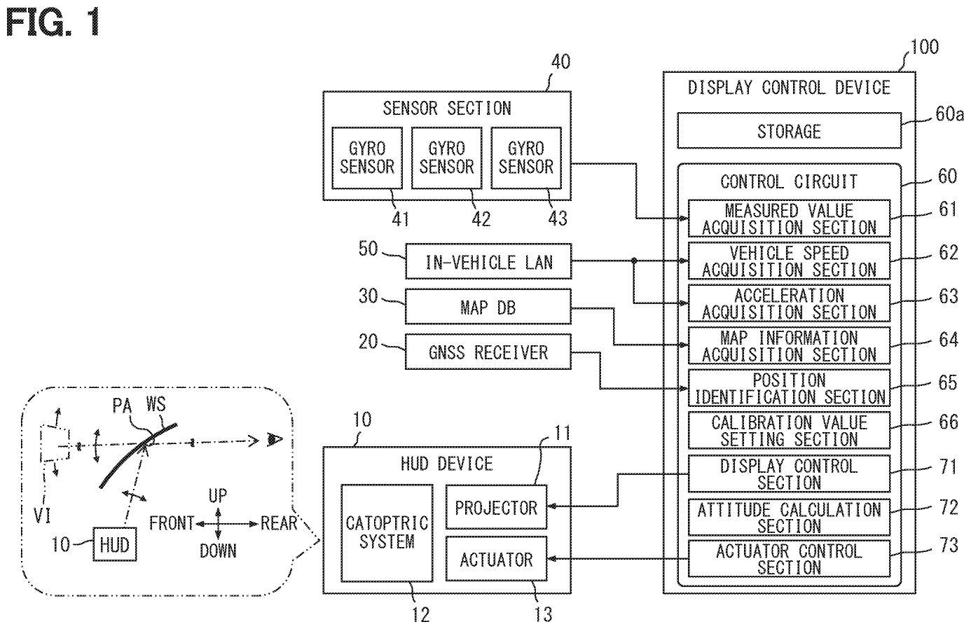

In a first embodiment of the present disclosure shown in FIG. 1, a function of a sensor calibration device is realized by a display control device 100. The display control device 100 is one of multiple electronic control units mounted on a vehicle. The display control device 100 is electrically connected to multiple display devices such as an HUD device 10 and a combination meter, and controls display of those devices. The display control device 100 is electrically connected directly or indirectly to an in-vehicle LAN 50, a map database (hereinafter referred to as “map DB”) 30, a GNSS receiver 20, a sensor section 40, and the like, in addition to the display devices such as the HUD device 10.

The HUD (Head-Up Display) device 10 is a display device that displays a virtual image VI in front of an occupant of the vehicle, for example, a driver of the vehicle. The virtual image VI is formed in a space in front of the vehicle and at a position of, for example, about 10 to 20 meters from an eye point of the driver. The virtual image VI is superimposed on a road surface and other vehicles in a view of the driver, thereby functioning as an augmented reality (hereinafter referred to as AR) indication. For example, warning information, route information, and the like are presented to the driver through the virtual image VI.

The HUD device 10 includes a projector 11, a catoptric system 12, and an actuator 13 as a configuration for displaying the virtual image VI. The projector 11 emits a light of a display image formed as the virtual image VI toward the catoptric system 12. The catoptric system 12 projects the light of the display image incident from the projector 11 onto a projection region PA of a windshield WS. The light projected onto the windshield WS is reflected toward the eye point side by the projection region PA and perceived by the driver. The actuator 13 changes an attitude of the catoptric system 12, thereby changing a projection position of the light of the display image in the projection region PA. The HUD device 10 described above changes a display position of the virtual image VI up and down in the view of the driver with the use of at least one of a drawing control of the display image drawn by the projector 11 and an attitude control of the catoptric system 12 by the actuator 13.

The in-vehicle LAN (Local Area Network) 50 is connected to a large number of electronic control units and a large number of vehicle-mounted sensors. Various kinds of information are output from the electronic control units and the vehicle-mounted sensors to the in-vehicle LAN 50. Vehicle speed information indicating a traveling speed of the vehicle, driving force information indicating a driving force of the vehicle, and the like are output to the in-vehicle LAN 50, for example.

The map DB 30 mainly includes a large-capacity storage medium for storing a large number of pieces of map data. Map data includes information on a curvature value, a gradient value, and a section length for each road, as well as information on non-temporary traffic regulations such as a speed limit of each road and one-way traffic. In addition, the map data includes coordinate information indicating longitude, latitude, and altitude at multiple points on the road as information indicating the position of the road in three dimensions. Each value of the longitude, the latitude, and the altitude included in the coordinate information is a value measured by high-precision positioning in order to enable autonomous driving of the vehicle.

The GNSS (Global Navigation Satellite System) receiver 20 receives positioning signals from multiple positioning satellites. The GNSS receiver 20 sequentially outputs the received positioning signals to the display control device 100. The GNSS receiver 20 is capable of receiving the positioning signals from respective positioning satellites of at least one satellite positioning system among satellite positioning systems such as GPS, GLONASS, Galileo, IRNSS, QZSS, and BeiDou.

The sensor section 40 is a motion sensor for detecting the attitude of the vehicle. The sensor section 40 is fixed to an arbitrary position of the vehicle, and measures a pitch, a roll, a yaw, and the like generated in the vehicle. The sensor section 40 has multiple gyro sensors 41 to 43 for measuring changes in the position of the center of gravity around a yaw axis, a pitch axis, and a roll axis of the vehicle, that is, changes in the attitude.

The gyro sensors 41 to 43 are, for example, sensors that detect an angular velocity as a voltage value. Each of the gyro sensors 41 to 43 is provided in different attitudes so as to be able to measure a magnitude of an angular velocity generated around each axis of an x-axis, a y-axis, and a z-axis which are orthogonal to each other. Each of the gyro sensors 41 to 43 measures a measured value around each axis, and sequentially outputs the measured value to the display control device 100. The orientations of the three axes defined in the sensor section 40 may be inclined with respect to the yaw axis, the pitch axis, and the roll axis in the vehicle.

The display control device 100 includes a control circuit 60, a storage 60a, an input/output interface, and the like. The control circuit 60 mainly includes a CPU (Central Processing Unit), a GPU (Graphics Processing Unit), a RAM (Random Access Memory), and the like. The storage 60a stores various programs to be executed by the control circuit 60. Specifically, a display control program for controlling the display of the virtual image VI, a sensor calibration program for calibrating the outputs of the gyro sensors 41 to 43, and the like are stored in the storage 60a.

The control circuit 60 configures multiple functional blocks by executing various programs stored in the storage 60a. Specifically, the control circuit 60 includes a display control section 71, an attitude calculation section 72, and an actuator control section 73 as functional blocks based on the display control program. The control circuit 60 includes a measured value acquisition section 61, a vehicle speed acquisition section 62, an acceleration acquisition section 63, a map information acquisition section 64, a position identification section 65, and a calibration value setting section 66 as functional blocks based on the sensor calibration program.

The display control section 71 controls the display of the virtual image VI by the HUD device 10. The display control section 71 selects a virtual image VI to be used for information presentation based on various types of information acquired through the in-vehicle LAN 50. The display control section 71 draws image data for displaying the selected virtual image VI, and sequentially outputs the rendered image data to the projector 11. With the display control process of the display control section 71 described above, a light of a display image based on the image data is projected from the projector 11 to the catoptric system 12.

The attitude calculation section 72 calculates a pitch angle θₚ, a roll angle θᵣ, and a yaw angle θ_{y} as the attitude information of the vehicle based on the outputs of the gyro sensors 41 to 43 acquired by the measured value acquisition section 61. A temperature drift occurs in the values of the gyro sensors 41 to 43 as an error caused by a change in an ambient temperature at which the sensor section 40 is installed. In addition, when an angle is calculated according to the angular velocity, an error (time drift) accompanied by a time integration also occurs. In order to correct error factors of the temperature drift and the time drift, the attitude calculation section 72 calibrates the measured values θ_{p_sens}, θ_{r_sens}, and θ_{y_sens} which are raw outputs of the gyro sensors 41 to 43 with the use of a calibration expression shown in Expression 1 below. Calibration coefficients aₚ, bₚ, aᵣ, bᵣ, a_{y}, and b_{y} in the calibration expression are values set by the calibration value setting section 66.

$$\{ \begin{matrix}{θ}_{p} = {a}_{p} \cdot {θ}_{p \_ sens} + {b}_{p} \\ {θ}_{r} = {a}_{r} \cdot {θ}_{r \_ sens} + {b}_{r} \\ {θ}_{y} = {a}_{y} \cdot {θ}_{y \_ sens} + {b}_{y}\end{matrix} \qquad [ Expression 1 ]$$

The actuator control section 73 operates the actuator 13 based on the attitude information of the vehicle calculated by the attitude calculation section 72, and moves a projection position of the light of the display image in the projection region PA in the vertical direction. Even when the attitude of the vehicle changes, the actuator control section 73 controls the attitude of the catoptric system 12 with the actuator 13 so that the deviation of the superimposed position of the virtual image VI caused by the attitude change of the vehicle is corrected. According to the control of the actuator control section 73, the virtual image VI can be maintained in a state in which the virtual image VI is correctly superimposed on an object in the view of the driver.

In addition to the attitude control by the actuator control section 73, or instead of the attitude control, the display control section 71 may perform a control to change an arrival position of the light of the display image projected from the projector 11 to the catoptric system 12. Even in the drawing control of the display control section 71 described above, the virtual image VI can be maintained in a state of being correctly superimposed on the object in the view of the driver.

The measured value acquisition section 61 acquires the angular velocities about the pitch axis, the roll axis, and the yaw axis of the vehicle detected by the respective gyro sensors 41 to 43 from the sensor section 40. When the three axes defined by the sensor section 40 are inclined with respect to the three axes of the vehicle, the measured value acquisition section 61 corrects the outputs of the respective gyro sensors 41 to 43 to angular velocities around the three axes of the vehicle by coordinate transformation. The measured value acquisition section 61 acquires the pitch angle θ_{p_sens}, the roll angle θ_{r_sens}, and the yaw angle θ_{y_sens} of the vehicle by time integrating the angular velocity around each axis.

The vehicle speed acquisition section 62 acquires vehicle speed information indicating the traveling speed of the vehicle, the vehicle speed information being output to the in-vehicle LAN 50. The acceleration acquisition section 63 acquires the drive force information indicating the driving force of the vehicle, the driving force information being output to the in-vehicle LAN 50. The acceleration acquisition section 63 acquires the acceleration information indicating the acceleration of the vehicle based on the driving force information and specification information such as a weight of the vehicle, an outer diameter of a tire, a gear ratio of a drive system, and the like.

The map information acquisition section 64 acquires three-dimensional map data including information on latitude, longitude, and altitude for the road on which the vehicle travels, from the map DB 30. More specifically, the map information acquisition section 64 requests the map DB 30 to provide the map data around the current position of the vehicle and the map data including the roads on which the vehicle has traveled. The map information acquisition section 64 may be capable of acquiring the map data around the vehicle through, for example, a communication network.

The position identification section 65 acquires the positioning signals from satellites received by the GNSS receiver 20. The position identification section 65 identifies the current positioning position of the vehicle based on the positioning signals. The vehicle speed acquisition section 62 and the acceleration acquisition section 63 may acquire the vehicle speed information and the acceleration information, respectively, based on the transition of the positioning position identified by the position identification section 65.

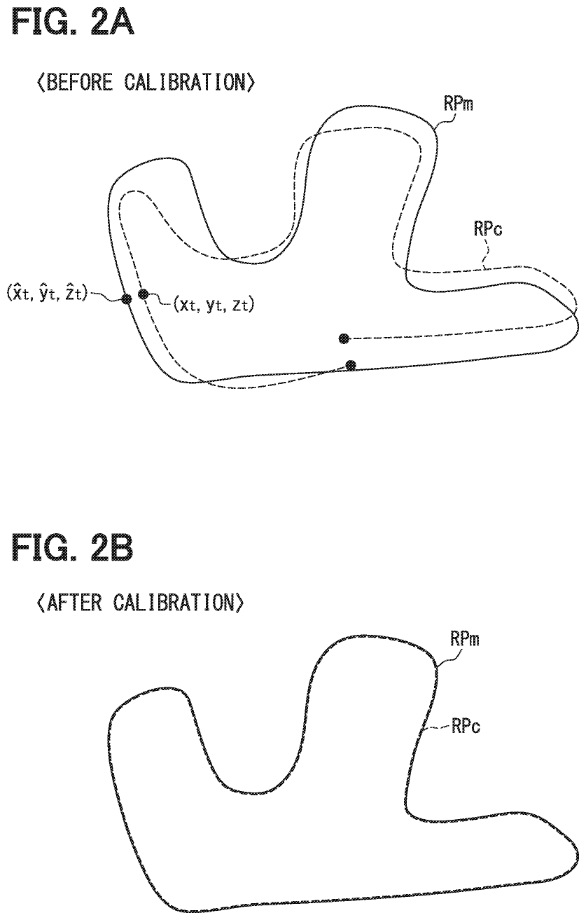

The calibration value setting section 66 sets a calibration coefficient (refer to Expression 1) applied to the measured value acquired by the measured value acquisition section 61. Specifically, the calibration value setting section 66 calculates a traveling locus RPc of the vehicle (refer to FIG. 2A and FIG. 2B) by using the coordinate calculation expression shown in Expression 2 below. The traveling locus RPc is a three-dimensional figure in which coordinates of the calculated position calculated based on the vehicle speed information and the measured values are connected in time series.

In the following coordinate calculation expression, v is a traveling speed of the vehicle indicated by the vehicle speed information. In addition, (xᵢ, yᵢ, zᵢ) are coordinates of the calculated position of the host vehicle at a time i, and (xᵢ₊₁, yᵢ₊₁, zᵢ₊₁) are coordinates of the calculated position of the host vehicle at a time i+1. Further, the pitch angle θₚ, the roll angle θᵣ, and the yaw angle θ_{y} are attitude angles based on the pre-calibration measured values θ_{p_sens}, θ_{r_sens}, θ_{y_sens}, or a calibration expression in which temporary calibration coefficients are set.

$$[ \begin{matrix}{x}_{i + 1} \\ {y}_{i + 1} \\ {z}_{i + 1}\end{matrix} ] = v [ \begin{matrix}\begin{matrix}- sin {θ}_{y} sin {θ}_{p} sin {θ}_{r} + cos {θ}_{r} cos {θ}_{y} - \\ sin {θ}_{y} cos {θ}_{p} + sin {θ}_{y} sin {θ}_{p} cos {θ}_{r} + sin {θ}_{r} cos {θ}_{y}\end{matrix} \\ \begin{matrix}cos {θ}_{y} sin {θ}_{p} sin {θ}_{r} + cos {θ}_{r} sin {θ}_{y} + \\ cos {θ}_{y} cos {θ}_{p} - cos {θ}_{y} sin {θ}_{p} cos {θ}_{t} + sin {θ}_{r} sin {θ}_{y}\end{matrix} \\ - cos {θ}_{p} sin {θ}_{r} + sin {θ}_{p} + cos {θ}_{p} cos {θ}_{r}\end{matrix} ] + [ \begin{matrix}{x}_{i} \\ {y}_{i} \\ {z}_{i}\end{matrix} ] \qquad [ Expression 2 ]$$

The calibration value setting section 66 sets a traveling locus RPm (refer to FIG. 2A and FIG. 2B) on which the vehicle is estimated to have traveled, based on shape information of the road shown in the map data. The calibration value setting section 66 assumes that the traveling locus RPm based on the map data is a true value. Then, the calibration value setting section 66 calculates a calibration coefficient such that the calculated traveling locus RPc comes close to (overlaps with) the traveling locus RPm based on the map data, that is, such that an error of the traveling locus RPc with respect to the traveling locus RPm is minimized.

More specifically, the calibration value setting section 66 sets coordinates on the traveling locus RPc corresponding to each of a large number of coordinates on the traveling locus RPm. The calibration value setting section 66 sets a pair of pieces of coordinate information estimated to indicate the position of the vehicle at the same time from each of the traveling loci RPm and RPc. The calibration value setting section 66 searches for a minimum value of an objective function as shown in Expression 3 below.

In the objective function, an error norm between coordinates (x\hat{ }ₜ, y\hat{ }ₜ, z\hat{ }ₜ) of a reference position on the traveling locus RPm and coordinates (xₜ, yₜ, zₜ) of the calculated position on the traveling locus RPc is calculated for the coordinates of the respective combined pairs. The calibration value setting section 66 sets the calibration coefficient such that a sum of the error norms becomes minimum. The calibration value setting section 66 searches for a calibration coefficient by an iterative calculation using a gradient method, for example.

$$min ( {\sum }_{t = 0}^{n} \sqrt{{( {\hat{x}}_{t} - {x}_{t} )}^{2} + {( {\hat{y}}_{t} - {y}_{t} )}^{2} + {( {\hat{z}}_{t} - {z}_{t} )}^{2}} ) \qquad [ Expression 3 ]$$

The calibration value setting section 66 determines a traveling state of the vehicle, and sets the calibration coefficient with the exclusion of the measured value measured in a specific traveling state. Specifically, the measured values measured by the respective gyro sensors 41 to 43 during acceleration and deceleration of the vehicle are excluded from an object data used for setting the calibration coefficient. In addition, the measured values measured by the respective gyro sensors 41 to 43 during a period when the vehicle passes through the unevenness of the road surface are also excluded from the object data used for setting the calibration coefficient.

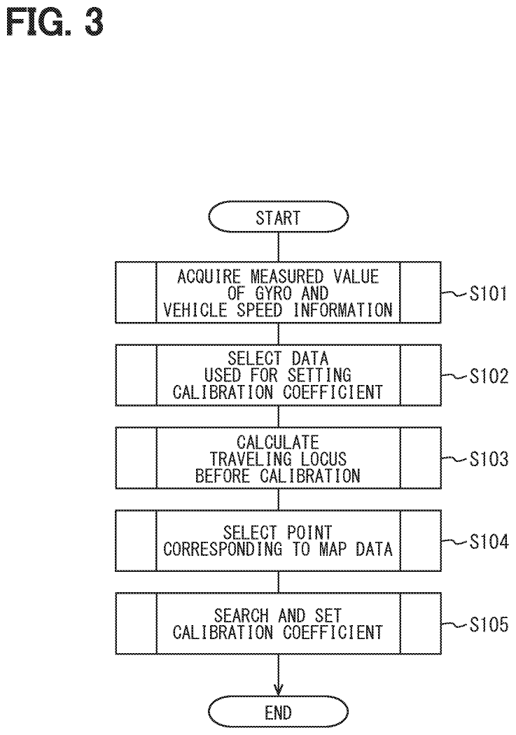

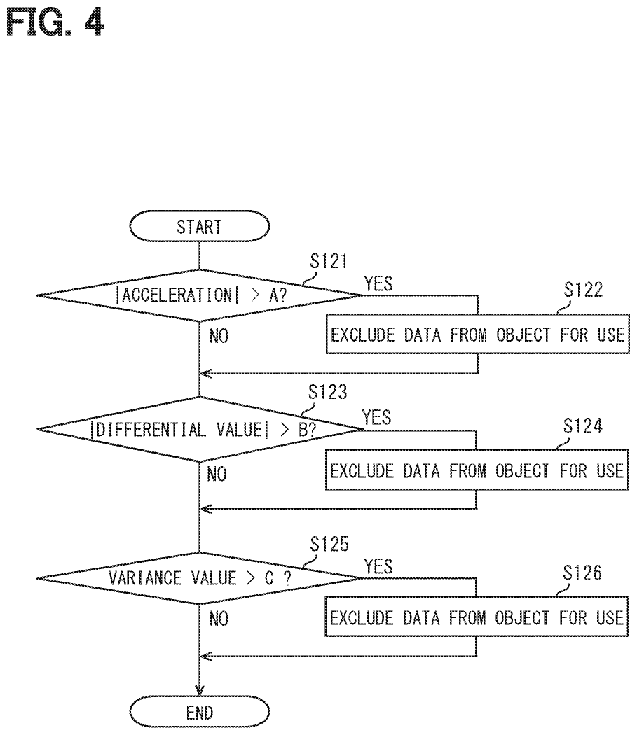

The display control device 100 described so far continuously performs an update process for updating the calibration coefficient. Hereinafter, details of the process of updating the calibration coefficient will be described based on FIGS. 3 and 4 with reference to FIG. 1. The update process shown in FIG. 3 is started by the control circuit 60 based on the fact that the vehicle is ready to travel. The update process is repeatedly performed by the control circuit 60 until a power supply or an ignition of the vehicle is turned off.

In S101, the measured values based on the outputs of the respective gyro sensors 41 to 43 and the vehicle speed information are acquired, and the process proceeds to S102. In S102, data to be used for setting the calibration coefficient is selected from the measured values acquired in S101. In other words, in S102, the measured values that may cause a large error in the calibration coefficient are excluded from an object to be used by the data selection process shown in FIG. 4.

In S121 of the data selection process, acceleration information during the period or the timing when the measured value is measured is acquired. Then, it is determined whether an absolute value of the acceleration occurring in the vehicle exceeds a threshold A. When it is determined in S121 that the absolute value of the acceleration is equal to or less than the threshold A, the process proceeds to S123. On the other hand, when it is determined that the absolute value of the acceleration exceeds the threshold A, the process proceeds to S122. In S122, the measured value during the period in which the absolute value of the acceleration exceeds the threshold A is excluded from the object used for setting the calibration coefficient, and the process proceeds to S123. As described above, data during acceleration and deceleration are excluded from the object to be used.

In S123, a differential value of the coordinates of the calculated position in the time series is calculated. The differential value may be, for example, a value (|xₜ−xₜ₋₁|) for one of the coordinates x, y, and z and may be a value of a spatial distance between the two coordinates. Note that xₜ is a value of the calculated position at a time t, and xₜ₋₁ is a value of the calculated position at a time t−1.

Then, it is determined whether an absolute value of the differential value of the coordinates exceeds a threshold B. If it is determined in S123 that the absolute value of the differential value is equal to or less than the threshold B, the process proceeds to S125. On the other hand, when it is determined in S123 that the absolute value of the differential value exceeds the threshold B, the process proceeds to S124. In S124, the measured value in a period in which the absolute value of the differential value exceeds the threshold B is excluded from the object to be used for setting the calibration coefficient, and the process proceeds to S125. As described above, for example, data when the attitude of the vehicle changes suddenly due to a passage of irregularities on the road surface or the like is excluded from the object to be used.

In S125, a variance value of the coordinates of the calculated position in a specified period (for example, several seconds) is calculated and it is determined whether the variance value exceeds the threshold C. If it is determined in S125 that the variance value is equal to or less than a threshold C, the process returns to S103 of the updating (main) process. On the other hand, when it is determined in S125 that the variance value exceeds the threshold C, the process proceeds to S126. In S126, the measured value in a period in which the variance value exceed the threshold C is excluded from the object used for setting the calibration coefficient, and the process returns to S103 of the main process shown in FIG. 3. As described above, the data in a period in which the attitude of the vehicle has changed due to some cause not appearing in the map data is excluded from the object to be used.

In S103, a pre-calibration traveling locus RPc is calculated by the above coordinate calculation expression (refer to Expression 2), and the process proceeds to S104. In S104, the map data is read out from the map DB 30, and the traveling locus RPm of the vehicle is set. Points corresponding to the individual coordinates on the traveling locus RPm, that is, coordinates closest to the individual coordinates are selected from a coordinate group of the calculated positions calculated in S103, and the process proceeds to S105.

In S105, the respective calibration coefficients of the calibration expression (refer to Expression 1) are calculated so that an error between the calculated position and the reference position associated in S104 is minimized, and the update process is once terminated.

In the first embodiment described so far, the calculated position is acquired by combining the measured values based on the outputs of the gyro sensors 41 to 43 and the vehicle speed information together. If the calibration coefficient is set so that the calculated position comes close to the reference position shown in the map data, the sensor section 40 can be calibrated using the map data. As a result, the gyro sensors 41 to 43 can be calibrated using the map data.

According to the above configuration, the accuracy of the attitude measurement of the vehicle by the gyro sensors 41 to 43 is improved. Therefore, the display control section 71 and the actuator control section 73 can move the virtual image VI in accordance with the change in the attitude of the vehicle with high accuracy. Therefore, the display control device 100 can accurately superimpose the virtual image VI on the object in the view of the driver.

The accuracy of the calibration can also be improved by improving the accuracy of the map data. In addition, additional components for calibration such as a temperature sensor are not required, thereby being capable of reducing the cost of the system.

In addition, the sensor section 40 according to the first embodiment is configured to measure the angular velocity around the three axes, and eventually the attitude angle. Even in such a configuration using the three-axis sensor section 40, if three-dimensional coordinates are shown in the map data, the measured values around each axis can be calibrated.

In the first embodiment, one point corresponding to the coordinates of the reference position indicated by the map data is selected from the coordinate group of the multiple calculated positions. As described above, the number of coordinates included in the map data is smaller than the number of coordinates calculated as the calculated position. Therefore, according to the process of associating the coordinates of the calculated position with the coordinates of the reference position, the display control device 100 can calculate the calibration coefficient with high accuracy by effectively using the available data.

Further, the calibration value setting section 66 according to the first embodiment calculates the calibration coefficient so that the sum of the error norms of the respective coordinates of the respective traveling loci RPm and RPc becomes minimum. With the calculation processing described above, the calculation load for searching for the calibration coefficient can be reduced while ensuring the accuracy of the calibration coefficient.

The measured values of the gyro sensors 41 to 43 during the period in which the position of the center of gravity of the vehicle is changed are values including the motion of the vehicle which is not included in the map data. Therefore, according to the first embodiment, the measured values during acceleration and deceleration accompanied by a change in the position of the center of gravity are excluded from the object used for setting the calibration coefficient. Specifically, the value of the acceleration of the vehicle is acquired as the acceleration information, and the measured value in the period estimated to be in the acceleration state or the deceleration state is excluded from the calculation of the calibration coefficient. According to the above configuration, the accuracy of the calibration coefficient calculated using the map data can be maintained at a high level.

Further, irregularities caused by, for example, aging deterioration of the road surface, joints, and the like are not shown in the map data. Therefore, the measured value at a timing of passing through the irregularities of the road surface is a value including a motion which is not included in the map data. For that reason, according to the first embodiment, the measured value in the period during which the vehicle passes through the irregularities of the road surface is excluded from the object used for setting the calibration coefficient. More specifically, a differential value over time is monitored with respect to the coordinates of the calculated position, and the measured value in the period in which a change range of the coordinates exceeds the threshold B is excluded from the calculation of the calibration coefficient. According to the above configuration, the accuracy of the calibration coefficient calculated using the map data can be maintained at a high level.

Further, according to the first embodiment, the variance value of the calculated position in the specific period is calculated, and the measured value in the period in which the variance value exceeds the threshold C is not used for calculation of the calibration coefficient. As described above, with the employment of the selection based on the variance value as the attitude change filter, the measured value in the period in which a large attitude change occurs due to a factor not included in the map data can be excluded from the calculation of the calibration coefficient. Therefore, the accuracy of the calibration coefficient can be maintained at a high level.

In the first embodiment, the map data corresponds to “map information”, the calibration coefficient corresponds to a “calibration value”, the gyro sensors 41 to 43 correspond to an “attitude sensor”, the control circuit 60 corresponds to a “processor”, and the display control device 100 corresponds to a “sensor calibration device”.

### Second Embodiment

In setting of a calibration coefficient according to a second embodiment, three-dimensional coordinates indicated by a positioning signal are used as a reference position instead of coordinates indicated by map data. A calibration value setting section 66 shown in FIG. 1 calculates a traveling locus RPc (refer to FIG. 2A and FIG. 2B) of a vehicle with the use of a coordinate calculation expression (refer to Expression 2) similar to that of the first embodiment. On the other hand, the calibration value setting section 66 according to the second embodiment sets a traveling locus RPm (refer to FIG. 2A and FIG. 2B) on which the vehicle is estimated to have traveled by a process of connecting positioning positions identified by a position identification section 65 in time series. The calibration value setting section 66 assumes that the traveling locus RPm based on a positioning signal is a true value, and calculates a calibration coefficient so that a calculated traveling locus RPc three-dimensionally overlaps with the traveling locus RPm based on the positioning signal, in other words, so that an error of the calculated position with respect to the positioning position is minimized.

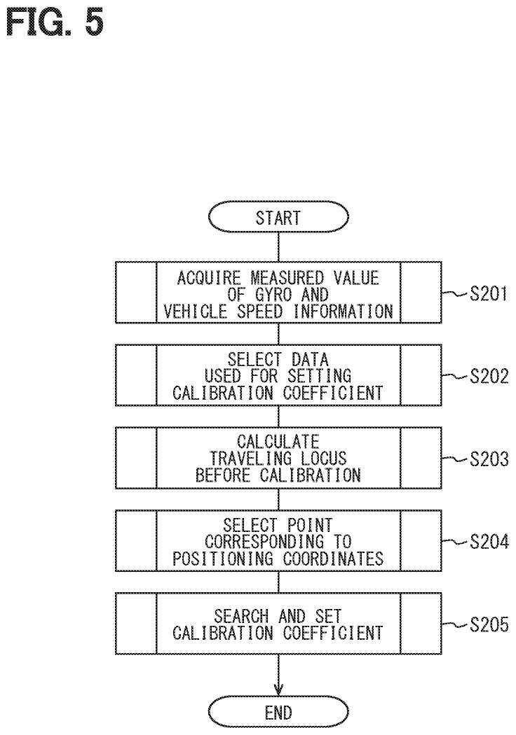

In the update process according to the second embodiment shown in FIG. 5, the content of S201 to S203, and S205 is substantially the same as the S101 to S103, and S105 of the first embodiment (refer to FIG. 3). On the other hand, in S204, coordinates (hereinafter referred to as “positioning coordinates”) based on the positioning position are read out from the position identification section 65, and a traveling locus RPm of the vehicle is set. Points corresponding to the respective positioning coordinates on the traveling locus RPm are selected from a coordinate group of the calculated positions calculated in S203. In S204, for example, the coordinates of the calculated position detected substantially at the same time and the positioning coordinates are linked with each other based on a time at which the coordinate information is acquired.

In the second embodiment described so far, the calibration coefficients of the gyro sensors 41 to 43 are set so that the calculated position based on the vehicle speed information and the measured value comes close to the positioning position identified based on the positioning signal. As a result, the gyro sensors 41 to 43 can be calibrated with the use of the positioning signals received from the positioning satellites. The accuracy of the calibration can also be improved by improving the positioning accuracy.

### Third Embodiment

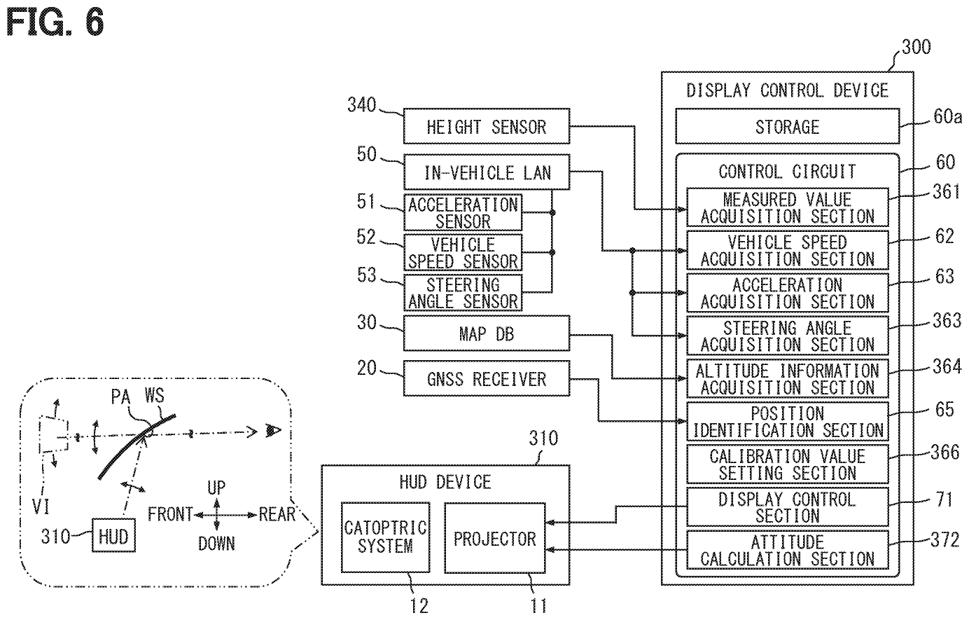

Also, in a third embodiment of the present disclosure shown in FIG. 6, a function of a sensor calibration device is realized by a display control device 300. The display control device 300 is electrically connected directly or indirectly to an HUD device 310, a height sensor 340, and the like, in addition to a GNSS receiver 20, a map DB 30, an in-vehicle LAN 50, and the like, which are substantially the same as those of the first embodiment.

An acceleration sensor 51, a vehicle speed sensor 52, a steering angle sensor 53, and the like are connected to the in-vehicle LAN 50. The acceleration sensor 51 detects an acceleration in the front-back direction acting on the vehicle, and outputs a detection result to the in-vehicle LAN 50. The vehicle speed sensor 52 is, for example, a sensor for measuring a wheel speed, and outputs a measurement signal corresponding to the vehicle speed to the in-vehicle LAN 50 as vehicle speed information. The steering angle sensor 53 detects a steering angle of a steering system, and outputs the detection result to the in-vehicle LAN 50. The steering angle may be a steering angle or may be an actual steering angle of a steering wheel.

Similar to the HUD device 10 of the first embodiment (refer to FIG. 1), the HUD device 310 uses AR display using a virtual image VI and non-AR display in combination to present information to a driver. The HUD device 310 includes a projector 11 and a catoptric system 12 as a configuration for displaying a virtual image VI. The projector 11 adjusts the position of an original image projected on the catoptric system 12 based on the information of an attitude angle (pitch angle θ, refer to Expression 4) acquired from the display control device 300, and maintains a state in which the AR-displayed virtual image VI is correctly superimposed on an object.

The height sensor 340 is a sensor for detecting a vehicle height. The height sensor 340 is capable of detecting at least a displacement in the vertical direction (heave) of a change in the attitude of the vehicle. The height sensor 340 may be, for example, located in a vehicle exterior and installed on any one of left and right rear suspensions. The height sensor 340 measures the amount of sinking of a specific wheel which is displaced in the vertical direction by the operation of a suspension arm suspended on a body relative to the body. The height sensor 340 measures a relative distance between the body and the suspension arm, and sequentially outputs a signal (for example, a potential) of the measured data to the display control device 300.

The height sensor 340 may be provided in multiple suspensions of the front, rear, left, and right of the vehicle. The measurement data of the height sensor 340 may be acquired by the display control device 300 through the in-vehicle LAN 50.

The display control device 300 includes a control circuit 60, a storage 60a, an input/output interface, and the like, which are substantially the same as those of the first embodiment. The storage 60a of the third embodiment also stores a sensor calibration program for calibrating an output of the height sensor 340 in addition to a display control program for controlling the display of the virtual image VI.

The control circuit 60 has functional blocks such as a display control section 71 and an attitude calculation section 372 by executing the display control program. The control circuit 60 has functional blocks such as a measured value acquisition section 361, a steering angle information acquisition section 363, a map information acquisition section 364, and a calibration value setting section 366 in addition to a vehicle speed acquisition section 62, an acceleration acquisition section 63, and a position identification section 65 by executing the sensor calibration program.

The attitude calculation section 372 calculates a pitch angle θ of the vehicle based on an output (for example, voltage value) of the height sensor 340 acquired by the measured value acquisition section 361. The attitude calculation section 372 calibrates a raw output (potential V) of the height sensor 340 through a calibration expression shown in Expression 4 below. V₀ in the calibration expression is an initial value of the output of the height sensor 340. Both a and b in the calibration expression are calibration coefficients, which are set by the calibration value setting section 366.

θ=α·(V−V₀)+b [Expression 4]

The measured value acquisition section 361 acquires a measured value of the vehicle displacement (heave) based on the output of the height sensor 340. The steering angle information acquisition section 363 acquires steering angle information indicating a steering angle of the vehicle output to the in-vehicle LAN 50. The map information acquisition section 364 acquires, from a map DB 30, information indicating a latitude, a longitude, and an altitude of the road on which the vehicle is traveling, and information indicating a transverse gradient (cant) of the road surface.

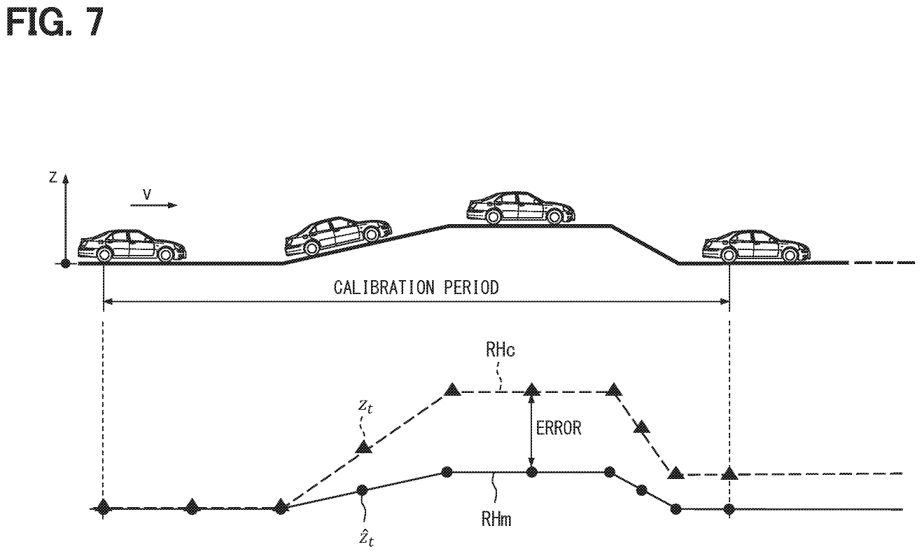

The calibration value setting section 366 sets a calibration coefficient (refer to Expression 4) to be applied to the measured value of the heave acquired by the measured value acquisition section 361. More specifically, with the use of the pitch angle θ and the vehicle speed, a provisional value of the altitude information of the host vehicle can be calculated. Such a calculated value has an error with respect to a true value of the altitude information (refer to a dashed line in FIG. 7) due to a change in a weight balance of an upper portion of the suspension caused by variations in the number of occupants and a load, aging degradation of the vehicle, and the like. The calibration value setting section 366 updates a calibration coefficient for correcting such an error, and sets the calibration coefficient suitable for the current vehicle. As a result, the attitude calculation section 372 can calculate the vehicle attitude angle (pitch angle θ) with high accuracy by calibrating the error factor.

Specifically, the calibration value setting section 366 calculates a host vehicle altitude RHc (refer to a dashed line in FIG. 7) through a coordinate calculation expression shown in Expression 5 below. The host vehicle altitude RHc is obtained by connecting the coordinates of the calculated position calculated based on the vehicle speed information and the measured value in time series.

In the following coordinate calculation expression, v is a traveling speed of the vehicle indicated by the vehicle speed information. In addition, (zᵢ) is a coordinate indicating an i-th calculated position in the calibration section, and (zᵢ₊₁) is a coordinate indicating an (i+1)-th calculated position. The pitch angle θ is an attitude angle based on a calibration expression (refer to Expression 4) in which a pre-calibration or a temporary calibration coefficient is set.

zᵢ₊₁=νcos θ+zᵢ [Expression 5]

Further, the calibration value setting section 366 sets a host vehicle altitude RHm (refer to a solid line in FIG. 7) based on the positioning position and the map data. The calibration value setting section 366 assumes that the host vehicle altitude RHm based on the map data is a true value. Then, the calibration value setting section 366 calculates a calibration coefficient such that the host vehicle altitude RHc calculated according to the measured value comes close to (overlaps with) the host vehicle altitude RHm based on the map data, that is, such that an error of the host vehicle altitude RHc with respect to the host vehicle altitude RHm is minimized.

Specifically, the calibration value setting section 366 sets a pair of pieces of coordinate information estimated to indicate the vehicle altitude at the same time from the respective host vehicle altitudes RHm and RHc. The calibration value setting section 366 searches for a minimum value of the objective function shown in Expression 6 below. In the objective function, an error norm is calculated between the coordinates (z\hat{ }ᵢ) of the reference position on the host vehicle altitude RHm and the coordinates (zᵢ) of the calculated position on the host vehicle altitude RHc for the respective pairs of combined coordinates. The calibration value setting section 366 searches for a calibration coefficient that minimizes the sum of error norms by iterative calculation using a gradient method. “n” in Expression 6 is the number of pieces of data used for calibration.

$$min ( {\sum }_{i = 0}^{n} \sqrt{{( {\hat{z}}_{i} - {z}_{i} )}^{2}} ) \qquad [ Expression 6 ]$$

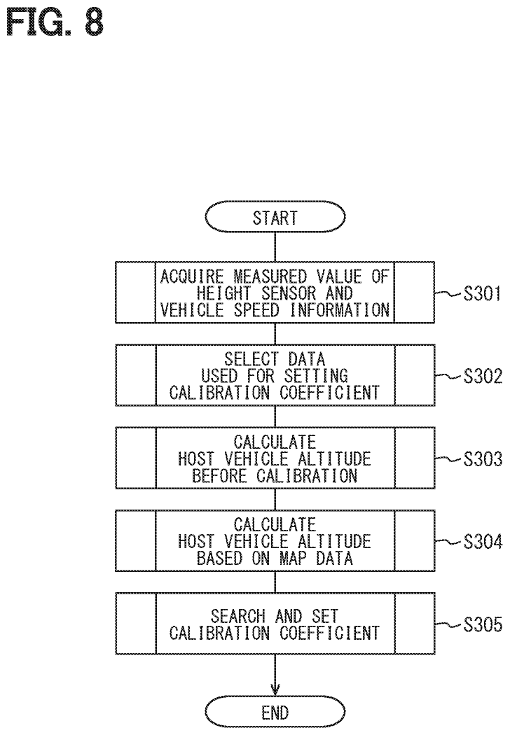

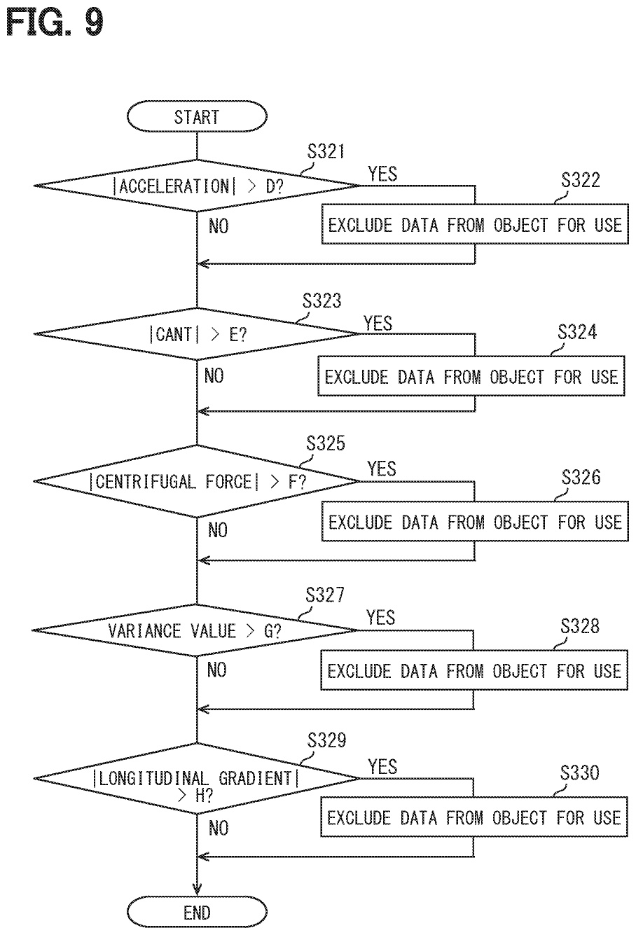

Next, the update process according to the third embodiment, which is continuously performed by the display control device 300, will be described in detail with reference to FIG. 6, based on FIGS. 8 and 9. The update process shown in FIG. 8 is started by the control circuit 60 based on the switching of the ignition to an on-state, and is repeated until the ignition is turned off, similarly to the first embodiment and the like.

In S301, the measured value based on the output of the height sensor 340 and the vehicle speed information are acquired, and the process proceeds to S302. In S302, among the measured values acquired in S301, the measured values that may cause a large error in the calibration coefficient are excluded from an object to be used by the data selection process shown as a sub-process in FIG. 9, and the data to be used for setting the calibration coefficient is selected.

In S321 of the data selection process, acceleration information during a period or a timing when the measured value is measured is acquired. Then, it is determined whether an absolute value of the acceleration occurring in the vehicle exceeds a threshold D. When it is determined in S321 that the absolute value of the acceleration is equal to or less than the threshold D, the process proceeds to S323. On the other hand, when it is determined that the absolute value of the acceleration exceeds the threshold D, the process proceeds to S322. In S322, the measured value during a period in which the absolute value of the acceleration exceeds the threshold D is excluded from the object used for setting the calibration coefficient, and the process proceeds to S323. As described above, data during acceleration and deceleration are excluded from the object to be used.

In S323, information on the cant of the road surface during traveling is acquired. Then, it is determined whether the absolute value of the cant exceeds a threshold E. If it is determined in S323 that the absolute value of the cant is equal to or less than the threshold E, the process proceeds to S325. On the other hand, when it is determined that the absolute value of the cant exceeds the threshold E, the process proceeds to S324. In S324, the measured value in the period in which the absolute value of the cant exceeds the threshold E is excluded from the object to be used for setting the calibration coefficient, and the process proceeds to S325.

In S325, the vehicle speed information and the steering angle information are acquired, and a magnitude of a centrifugal force acting on the vehicle is estimated. Then, it is determined whether the absolute value of the estimated centrifugal force exceeds a threshold F. If it is determined in S325 that the absolute value of the centrifugal force is equal to or less than the threshold F, the process proceeds to S327. On the other hand, when it is determined that the absolute value of the centrifugal force exceeds the threshold F, the process proceeds to S326. In S326, the measured value in the period in which the absolute value of the centrifugal force exceeding the threshold F is excluded from the object to be used for setting the calibration coefficient, and the process proceeds to S327.

With the processing of S323 to S326 described above, the data during the curve traveling is excluded from the object to be used.

In S327, a variance value of the coordinates of the calculated position in a specified period is calculated, and it is determined whether the variance value exceeds a threshold G. If it is determined in S327 that the variance value is equal to or less than the threshold G, the process proceeds to S329. On the other hand, when it is determined that the variance value exceeds the threshold G, the process proceeds to S328. In S328, the measured value in the period in which the variance value exceeds the threshold G is excluded from the object used for setting the calibration coefficient, and the process proceeds to S329.

In S329, the longitudinal gradient of the road surface during traveling is calculated according to information on latitude, longitude, and altitude indicated by the map data, and it is determined whether an absolute value of the longitudinal gradient exceeds a threshold H. If it is determined in S329 that the absolute value of the longitudinal gradient is equal to or less than the threshold H, the process returns to the S303 of the update (main) process. On the other hand, when it is determined in S329 that the absolute value of the longitudinal gradient exceeds the threshold H, the process proceeds to S330. In S330, the measured value in the period in which the absolute value of the longitudinal gradient exceeds the thresholds H is excluded from the object used for setting the calibration coefficient, and the process returns to S303 of the main process shown in FIG. 8. As described above, the data in the period in which the attitude change accompanying an ascent and a descent is remarkable is excluded from the object to be used.

In S303, the pre-calibration host vehicle altitude RHc is calculated based on the measured value, and the process proceeds to S304. In S304, the host vehicle altitude RHm is calculated based on the map data. Then, the coordinates closest to the point (coordinates) corresponding to the individual coordinates on the host vehicle altitude RHm are selected from a coordinate group of the calculated positions calculated in S303, and the process proceeds to S305. In S305, the calibration coefficients a and b of the calibration expression (refer to Expression 4) are calculated so that an error between the calculated position and the reference position associated with each other in S304 is minimized, and the update process is once terminated.

In the third embodiment described so far, the calculated position for the altitude is acquired by combining the measured value based on the output of the height sensor 340 and the vehicle speed information together. If the calibration coefficient is set so that the calculated position comes close to the reference position, the height sensor 340 can be calibrated with the use of the altitude information.

According to the setting of the calibration coefficient as described above, since the accuracy of the attitude measurement based on the measured value of the height sensor 340 is improved, the display control section 71 can move the virtual image VI with high accuracy in accordance with a change in the attitude of the vehicle. Therefore, the display control device 300 can accurately superimpose the virtual image VI on the object in the view of the driver.

In addition, as in the third embodiment, a high accuracy can be ensured in the reference position set using the altitude information included in the map data. Therefore, the accuracy of the calculated calibration coefficient, and thus the accuracy of the pitch angle to which the calibration coefficient is applied, can be maintained at a high level.

In this example, the measured value of the height sensor 340 acquired while the vehicle is traveling on a curve may include not only a component caused by a change in the altitude but also a component caused by a roll change accompanying the travel on the curve. Therefore, in the third embodiment, the measured value measured during the curve travel is excluded from the object used for setting the calibration coefficient. Specifically, it is determined whether to use the measured value based on information such as the steering angle and the corresponding speed of the vehicle, and the cant. According to the above processing, an influence of the roll change which inevitably occurs when the one-way displacement sensor is used can be reduced, and therefore, the accuracy of the calibration coefficient can be maintained at a high level.

Further, in a scene where the gradient of the road is large during traveling, a component caused by the pitch change may be included in the measured value of the height sensor 340. Therefore, in the third embodiment, the measured value of the period in which the longitudinal gradient of the road surface exceeds the threshold H is not used for setting the calibration coefficient. According to the above processing, since the influence of the change in the pitch of the vehicle can be reduced, the accuracy of the calibration coefficient can be maintained at a higher level.

In the third embodiment, the height sensor 340 corresponds to an “attitude sensor”, the map information acquisition section 364 corresponds to an “altitude information acquisition section”, and the display control device 300 corresponds to a “sensor calibration device”.

### Fourth Embodiment

In setting of a calibration coefficient according to a fourth embodiment, instead of coordinates of an altitude indicated by three-dimensional map data, coordinates of an altitude indicated by a positioning signal are used as a reference position. A calibration value setting section 366 shown in FIG. 6 calculates a host vehicle altitude RHc (refer to FIG. 7) of a vehicle through the same coordinate calculation expression (refer to Expression 5) as in the third embodiment. On the other hand, the calibration value setting section 366 sets a host vehicle altitude RHm (refer to FIG. 7) in a traveling locus of the vehicle by a process of connecting positioning positions identified by a position identification section 65 in time series. The calibration value setting section 366 assumes that the host vehicle altitude RHm based on the positioning signal is a true value, and calculates calibration coefficients a and b (refer to Expression 4) so that an error between the calculated host vehicle altitude RHc and the host vehicle altitude RHm based on the positioning signal is minimized.

In the fourth embodiment described so far, similarly to the third embodiment, a calibration coefficient of a height sensor 340 is set so that the calculated position based on the vehicle speed information and the measured value comes close to a reference position based on the positioning signal. As a result, an accuracy of a pitch angle using the measured value of the height sensor 340 and a superimposition accuracy of a virtual image VI can be maintained at a high level.

### Other Embodiments

Although a plurality of embodiments of the present disclosure have been described above, the present disclosure is not construed as being limited to the above-described embodiments, and can be applied to various embodiments and combinations within a range that does not depart from the spirit of the present disclosure.

In the data selection process (refer to FIG. 4) according to the embodiment described above, the measured values that can reduce the accuracy of the calibration coefficient by successively performing a plurality of determinations are excluded from the object to be used. The threshold used for the selection of such data may be appropriately set to a value capable of securing the accuracy of the calibration coefficient in accordance with the specification information such as a weight of the vehicle and a wheel base, an assumed road environment, and the like. Further, the selection of data by the data selection process may not be performed. Further, the content of the data selection process can be changed as appropriate.

### Modification 1

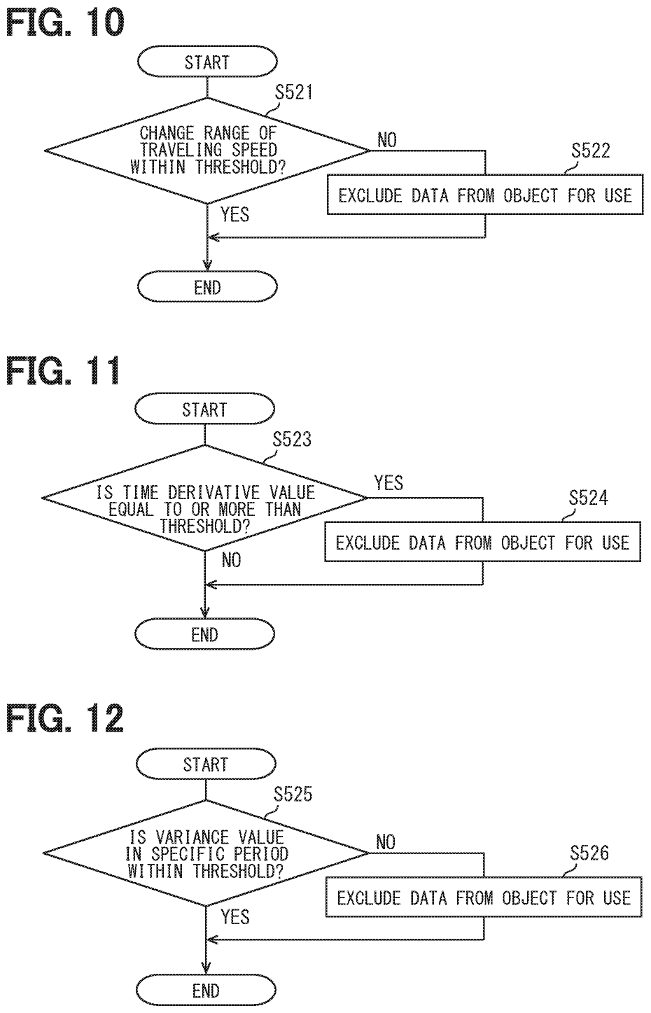

For example, in a data selection process according to Modification 1 shown in FIG. 10, the calibration value setting section determines whether a change range of the traveling speed is less than or equal to a threshold (S521). Then, data in a period in which a change range of the traveling speed exceeds a threshold, such as during acceleration and deceleration as in a starting scene and a stopping scene, are excluded from the object to be used for calculation of the calibration coefficient (S522). As a result, the calibration value setting section can set the calibration coefficient by selectively using only the measured value whose traveling speed falls within the threshold defining a constant change range for a constant time.

### Modification 2

In a data selection process according to Modification 2 shown in FIG. 11, the calibration value setting section determines whether a time derivative value of the calculated position is equal to or larger than a threshold (S523). The time derivative value is, for example, an amount of change per sampling cycle. Data in a period in which the time derivative value exceeds the threshold, such as timing at which data passes through irregularities, is excluded from the object to be used for calculation of the calibration coefficient (S524). As described above, the calibration value setting section can set the calibration coefficient by selectively using only the measured value in a period in which a time derivative value is small.

### Modification 3

In a data selection process according to Modification 3 shown in FIG. 12, the calibration value setting section determines whether a variance value in a specified period is less than or equal to a threshold (S525). Then, data in a period in which the variance value exceeds the threshold, such as in a period in which the attitude of the vehicle is greatly changed, is excluded from an object used for calculation of the calibration coefficient (S526). As described above, the calibration value setting section can set the calibration coefficient by selectively using only the measured value in the period in which the variance value is small.

### Modification 4

In the embodiment described above, the attitude angles of the pitch axis, the roll axis, and the yaw axis can be calibrated with the use of the three-dimensional map data. However, the sensor section to be calibrated may be appropriately changed. For example, the measured value acquisition section according to Modification 4 acquires the measured value for the yaw angle of the vehicle based on the output from the sensor section, and does not acquire the measured values for the pitch angle and the roll angle. On the other hand, the map information acquisition section acquires two-dimensional map data including latitude and longitude information. The calibration value setting section can calculate the coordinates of the calculated position of only the latitude and longitude based on the vehicle speed information and the measured value of the yaw angle. In other words, the calibration value setting section can define a two-dimensional traveling locus RPc based on the calculated position and a two-dimensional traveling locus RPm based on the map data. Therefore, similarly to the first embodiment, the correction coefficient such that the traveling locus RPc overlaps with the traveling locus RPm is searched so that the calibration value setting section can perform the calibration of the yaw angle using the two-dimensional map data. The yaw angle may be calibrated using only latitude and longitude information in the three-dimensional map data.

In the embodiment described above, the process of calibrating the gyro sensor for measuring the values indicating the pitch, roll, and yaw of the vehicle has been described. However, the attitude sensor to be calibrated is not limited to a gyro sensor. For example, the acceleration sensor may be an attitude sensor to be calibrated. The sensor section may be a so-called six-axis sensor including an acceleration sensor for measuring an acceleration in a direction along the three axes in addition to three gyro sensors for measuring angular velocities of the three axes. Further, in addition to the map data, the positioning information, and the like, information such as the ambient temperature around the sensor section may be further used for calculating the calibration coefficient.

In the first embodiment described above, the map data is set as a true value, and the calibration coefficient is set. In the second embodiment described above, the calibration coefficient is set with the positioning position as the true value. The processes described above may be combined with each other. For example, a reception state determination section for determining whether a reception state of the satellite signal is excellent is provided, and when it is determined that the accuracy of the positioning position is ensured, the setting of the calibration coefficient with the positioning signal as the true value is performed. On the other hand, when it is determined that the accuracy of the positioning position is not secured, the calibration coefficient is set with the map data as the true value. Alternatively, an accuracy determination section for determining the accuracy of the map data is provided, and when it is determined that the accuracy of the map data is ensured, a calibration coefficient is set with the map data as the true value. On the other hand, when it is determined that the accuracy of the map data is not ensured, the calibration coefficient is set with the positioning signal as the true value.

In the first embodiment and the like, an actuator control section and an actuator are provided in order to maintain a state in which a virtual image is correctly superimposed on an object. However, unlike the third embodiment, the adjustment of the display position of the virtual image by hardware may not be performed. In other words, the actuator control section and the actuator may be omitted. In the above configuration, as described above, the adjustment of the display position of the virtual image is performed by the adjustment of the image data drawn by the display control section, specifically, the position adjustment of an original image formed as the virtual image. As described above, the state in which the virtual image is correctly superimposed on the object may be maintained only by software processing. Alternatively, a state in which the virtual image is correctly superimposed on the object may be maintained only by the actuator control section and the actuator.

### Modification 5

In Modification 5, which is a modification of the third embodiment, the altitude information is acquired based on the gradient value. More specifically, the control circuit of Modification 5 is provided with a gradient value calculation section. The gradient value calculation section estimates the value (gradient value) of the road surface gradient (longitudinal gradient) from the response of the vehicle speed or acceleration to a tire driving force such as an accelerator opening degree and a brake hydraulic pressure while referring to an estimated weight of the vehicle. The altitude information acquisition section can acquire the altitude information serving as the reference position based on the gradient value and the vehicle speed information. In Modification 5 described above, even if the control circuit does not have the map information acquisition section and the position identification section, in other words, even if the map DB and the GNSS receiver are not mounted on the vehicle, the calibration value setting section can update the calibration coefficient.

In the third embodiment, the height sensor for measuring the displacement in the vertical direction is exemplified as a unidirectional displacement sensor. However, the update process of the calibration value according to the present disclosure is applicable not only to the displacement sensor in the vertical direction but also to a displacement sensor that measures a displacement in an arbitrary direction. More specifically, if the measured value of the displacement sensor is converted into the amount of displacement in the vertical direction with the use of the design value of the mounting angle of the displacement sensor to the vehicle, the same handling as that of the height sensor can be performed.

Further, as the pseudo displacement sensor, an acceleration sensor capable of detecting an acceleration component in the vertical direction may be used. If the calculation processing for integrating the measured values of the acceleration sensor twice is used as the amount of displacement in the vertical direction, the acceleration sensor can be handled in the same manner as the height sensor.

In the embodiment described above, in order to avoid an increase in error due to the influence of the roughness and level difference of the road surface, the measured value including the influence of the roughness and level difference of the road surface is excluded from the object used for the calibration coefficient with the use of information such as a variance value of the measured value or a time difference of the measured value in order to avoid the increase in error due to the influence of the roughness and level difference of the road surface, which is not included in the map data. The occurrence of such roughness and the level difference on the road surface may be estimated on the basis of the frequency of the measured value, for example, in addition to the variance value and the time difference.

In addition, in the third embodiment, in order to avoid an increase in error due to the influence of the roll angle component during the curve travel, the use and non-use of the measured value are classified on the basis of the magnitude of the centrifugal force. For example, instead of the centrifugal force, the calibration value setting section may select the use or non-use of the measured value on the basis of the magnitude of the steering angle, for example, to remove the roll angle component.

The combination of the multiple exclusion conditions described in the embodiment and the modification may be appropriately changed. Further, the exclusion condition may not be set. In addition, a specific value of the threshold may be changed as appropriate.

For example, in the three embodiments described above, thresholds as exclusion conditions are set for both the centrifugal force and the cant, and the measured values estimated to contain substantially no roll angle component in both the determinations are selectively used. However, in order to secure an available measured value, the calibration value setting section may perform a filter processing of summing up the magnitude of the roll angle based on the centrifugal force and the magnitude of the cant, for example, and excluding the measured value in a period in which the summed value exceeds a threshold based on the comparison between the summed value and the threshold.

Further, when the displacement sensor is provided in the multiple suspensions, the exclusion condition for excluding the measured value may be relaxed. For example, a process of averaging the measured values of the multiple height sensors is performed so that the rough road surface condition and the measured value during the curve travel may be used for calculation of the calibration coefficient. In addition, the amount of data of the measured value used for the calculation of the calibration coefficient may be increased while avoiding the influence of the road surface irregularities by processing or the like for excluding only the measured value showing a singular change. According to the processing described above, the extension of the calibration section can be performed.

In calculating the calibration coefficient, the calibration value setting section according to the above embodiment calculates a value at which the error between the traveling locus and the host vehicle altitude is minimum by the gradient method. However, the solution to the minimization problem of searching for the calibration coefficient is not limited to the gradient method. For example, when a range of the calibration coefficient (calibration parameter) is narrowed down to a certain degree, the calibration value setting section may obtain the minimum value by the total number inspection.

Further, when the calculated value (calculated position) of the displacement sensor before calibration is greatly deviated from the true value (reference position), the minimum value cannot be searched by the gradient method or the like. In that case, the calibration value setting section normalizes a series of calculated values so that the maximum value of the calculated values of the displacement sensor before calibration coincides with a maximum value of the true values. In this manner, when the normalized calculated value is used, the calibration value setting section can search for the minimum value.

The function of the sensor calibration device may be realized by a configuration different from that of the display control device 100. For example, a display device such as a combination meter and an HUD device may function as a sensor calibration device by executing a sensor calibration program by a control circuit. Further, the control circuit of the autonomous driving ECU mounted on the vehicle may function as a processor that executes the sensor calibration method of the present disclosure based on the sensor calibration program. Alternatively, a plurality of control circuits such as a display control device, a display device, and an autonomous driving ECU may perform distributed processing of calculations for sensor calibration. In addition, various non-transitory tangible storage media (non-transitory tangible storage medium) such as flash memories and hard disks can be employed as storages for storing sensor calibration programs and the like to be executed by the processor.

In the above embodiment, the calibration value of the attitude sensor is set by using high-precision map information as a reference. However, high-precision map information is not generated for all roads, and only map information with insufficient accuracy may exist. In this manner, map information with insufficient accuracy can be corrected based on the output of the attitude sensor. In other words, the map information may be updated such that the traveling locus RPm (refer to FIG. 2A and FIG. 2B) identified from the map information is superimposed on the traveling locus RPc (refer to FIG. 2A and FIG. 2B) calculated based on the output of the attitude sensor and the traveling speed. Such a technical idea will be added below.

A map correction device for correcting map information by travel of a vehicle, the map correction device including a measured value acquisition section that acquires a measured value of an attitude of the vehicle based on an output of an attitude sensor fixed to the vehicle, a vehicle speed acquisition section that acquires vehicle speed information indicating a traveling speed of the vehicle, a map information acquisition section that acquires map information of a road on which the vehicle travels, and a map update section that updates position information so that position information defining a position on the road by the map information matches a calculated position of the vehicle calculated based on the vehicle speed information and the measured value.

According to the configuration described above, even when there is only map information with insufficient accuracy, the accuracy of the position information of the map information can be enhanced by the traveling of the vehicle. In addition, for example, if there is information indicating the accuracy of the map information, the information as the true value can be switched between the position information and the calculated information. More specifically, when high precision map information is acquired, the position information indicated by the map information is regarded as a true value and is set as a reference position. Then, the calibration value setting section sets the calibration value of the attitude sensor by matching the calculated position with the reference position based on the map information. On the other hand, when the map information with low accuracy is acquired, the calculated position based on the measured value of the attitude sensor is set as the true value. Then, the map update section performs a process of matching the road position indicated in the map information with the calculated position, thereby improving the accuracy of the map.

The flowcharts or the processes of the flowcharts described in the present disclosure are configured by a plurality of sections (or steps), and each section is represented as S101, for example. Furthermore, each section may be divided into a plurality of sub-sections, while a plurality of sections may be combined into one section.

In addition, each section configured in this manner may be referred to as a circuit, a device, a module, or a means.

Also, each or a combination of the plurality of sections may be implemented as (i) a section of software in combination with a hardware section (for example, a computer), as well as (ii) a section of hardware (for example, an integrated circuit, a wired logic circuit), with or without the functionality of the associated device. Further, the hardware section can be configured inside the microcomputer.

Although the present disclosure has been described in accordance with the examples, it is understood that the present disclosure is not limited to such examples or structures. The present disclosure encompasses various modifications and variations within the scope of equivalents. In addition, various combinations and configurations, as well as other combinations and configurations that include only one element, more, or less, are within the scope and spirit of the present disclosure.

What is claimed is:

1. A sensor calibration device comprising a control circuit configured to:
acquire a measured value of an attitude of a vehicle based on an output of an attitude sensor;
acquire vehicle speed information indicating a traveling speed of the vehicle;
acquire map information on a road on which the vehicle travels; and
set a calibration value applied to the measured value to cause a calculated position of the vehicle calculated based on the vehicle speed information and the measured value to come close to a reference position indicated in the map information.

2. The sensor calibration device according to claim 1, wherein the control circuit is further configured to:
acquire the measured values indicating a pitch, a roll, and a yaw of the vehicle based on the output of the attitude sensor; and
acquire three-dimensional map information including information on latitude, longitude, and altitude.

3. The sensor calibration device according to claim 1, wherein the control circuit is further configured to:
acquire the measured value indicating a yaw of the vehicle based on the output of the attitude sensor, and
acquire two-dimensional map information including information on latitude and longitude.

4. The sensor calibration device according to claim 1, wherein the control circuit is further configured to:
select the calculated position corresponding to the reference position; and
search for the calibration value to minimize an error between the calculated position that is selected and the reference position.

5. A sensor calibration device comprising a control circuit configured to:
acquire a measured value of an attitude of a vehicle based on an output of an attitude sensor;
acquire vehicle speed information indicating a traveling speed of the vehicle;
identify a positioning position of the vehicle based on a positioning signal received from a positioning satellite; and
set a calibration value applied to the measured value to cause a calculated position of the vehicle calculated based on the vehicle speed information and the measured value to come close to the positioning position identified by the position identification section.

6. A sensor calibration device comprising a control circuit configured to:
acquire a measured value of a displacement of a vehicle based on an output of an attitude sensor;
acquire vehicle speed information indicating a traveling speed of the vehicle;
acquire altitude information on a road on which the vehicle travels; and
set a calibration value applied to the measured value to cause a calculated position of the vehicle calculated based on the vehicle speed information and the measured value to come close to a reference position indicated in the altitude information.

7. The sensor calibration device according to claim 6, wherein
the altitude information acquisition section acquires map information including the altitude information, and
the calibration value setting section sets the calibration value to cause the calculated position to come close to the reference position using the altitude information based on the map information.

8. The sensor calibration device according to claim 6, wherein the control circuit is further configured to:
acquire the altitude information based on a positioning signal received from a positioning satellite, and
set the calibration value to cause the calculated position to come close to the reference position using the altitude information based on the positioning signal.

9. The sensor calibration device according to claim 6, wherein the control circuit is further configured to:
acquire the altitude information based on a gradient value of a road surface of the road on which the vehicle travels, and
set the calibration value to cause the calculated position to come close to the reference position using the altitude information based on the gradient value.

10. The sensor calibration device according to claim 6, wherein the control circuit is further configured to set the calibration value with exclusion of the measured value measured by the attitude sensor while the vehicle is traveling on a curve.

11. The sensor calibration device according to claim 10, wherein the control circuit is further configured to exclude, from an object used for setting the calibration value, the measured value in a period in which a steering angle of the vehicle or a centrifugal force acting on the vehicle exceeds a threshold.

12. The sensor calibration device according to claim 10, wherein the control circuit is further configured to exclude, from an object used for setting the calibration value, the measured value in a period in which a transverse gradient of a road surface of the road on which the vehicle travels exceeds a threshold.

13. The sensor calibration device according to claim 10, wherein the control circuit is further configured to exclude, from an object used for setting the calibration value, the measured value in a period in which a longitudinal gradient of a road surface of the road on which the vehicle travels exceeds a threshold.

14. The sensor calibration device according to claim 1, wherein the control circuit is further configured to set the calibration value with exclusion of the measured value measured by the attitude sensor while the vehicle is accelerating and decelerating.

15. The sensor calibration device according to claim 14, wherein the control circuit is further configured to set the calibration value by using the measured value in a period in which a change range of the traveling speed indicated by the vehicle speed information falls within a threshold.

16. The sensor calibration device according to claim 14, wherein the control circuit is further configured to:
acquire acceleration information indicating an acceleration of the vehicle; and
exclude, from an object used for setting the calibration value, the measured value in a period in which an absolute value of the acceleration indicated by the acceleration information exceeds a threshold.

17. The sensor calibration device according to claim 1, wherein the control circuit is further configured to set the calibration value with exclusion of the measured value measured by the attitude sensor in a period in which the vehicle passes through an unevenness of a road surface.

18. The sensor calibration device according to claim 17, wherein the control circuit is further configured to set the calibration value with exclusion of the measured value in a period in which a time derivative value of the calculated position exceeds a threshold.

19. The sensor calibration device according to claim 17, wherein the control circuit is further configured to set the calibration value with exclusion of the measured value in a period in which a differential value of the calculated position over time exceeds a threshold.

20. The sensor calibration device according to claim 1, wherein the control circuit is further configured to set the calibration value with exclusion of the measured value in a period in which a variance value of the calculated position exceeds a threshold.

21. A sensor calibration program product stored in a non-transitory tangible storage medium and causing at least one processor to function as:
a measured value acquisition section that acquires a measured value of an attitude of a vehicle based on an output of an attitude sensor;
a vehicle speed acquisition section that acquires vehicle speed information indicating a traveling speed of the vehicle;
a map information acquisition section that acquires map information of a road on which the vehicle travels; and
a calibration value setting section that sets a calibration value applied to the measured value to cause a calculated position of the vehicle calculated based on the vehicle speed information and the measured value to come close to a reference position indicated in the map information.

22. A sensor calibration program product stored in a non-transitory tangible storage medium and causing at least one processor to function as:
a measured value acquisition section that acquires a measured value of an attitude of a vehicle based on an output of an attitude sensor;
a vehicle speed acquisition section that acquires vehicle speed information indicating a traveling speed of the vehicle;
a position identification section that identifies a positioning position of the vehicle based on a positioning signal received from a satellite; and
a calibration value setting section that sets a calibration value applied to the measured value to cause a calculated position of the vehicle calculated based on the vehicle speed information and the measured value to come close to the positioning position identified by the position identification section.

23. A sensor calibration program product stored in a non-transitory tangible storage medium and causing at least one processor to function as:
a measured value acquisition section that acquires a measured value of a displacement of a vehicle based on an output of an attitude sensor;
a vehicle speed acquisition section that acquires vehicle speed information indicating a traveling speed of the vehicle;
an altitude information acquisition section that acquires altitude information of a road on which the vehicle travels; and
a calibration value setting section that sets a calibration value applied to the measured value to cause a calculated position of the vehicle calculated based on the vehicle speed information and the measured value to come close to a reference position indicated in the altitude information.
